(19) United States
(12) Patent Application Publication
(10) Pub. No.: US 2011/0222058 A1
(43) Pub. Date: Sep. 15, 2011

(54) PROCESS MONITORING DEVICE AND SEMICONDUCTOR PROCESSING APPARATUS INCLUDING THE SAME

(75) Inventors: Se-Yeon KIM, Gyeonggi-do (KR); HunJung Yi, Suwon-si (KR)

(73) Assignee: Samsung Electronics Co., Ltd.

(21) Appl. No.: 13/048,387

(22) Filed: Mar. 15, 2011

(30) Foreign Application Priority Data
Mar. 15, 2010 (KR) 10-2010-0022927

(51) Int. Cl. G01J 3/28

(52) U.S. Cl. 356/316

(57) ABSTRACT

Provided are a process monitoring device for monitoring semiconductor device manufacturing processes, a semiconductor process apparatus including the same, and a process monitoring method thereof. The process monitoring device generates plasma from the exhaust gas of the process chamber using DBD-type electrodes and analyzes a spectrum of emission light from the plasma, thereby monitoring the semiconductor manufacturing process performed in the process chamber.

### CROSS-REFERENCE TO RELATED APPLICATIONS

This U.S. non-provisional patent application claims priority under 35 U.S.C. §119 to Korean Patent Application No. 10-2010-0022927, filed on Mar. 15, 2010, the entire contents of which are hereby incorporated by reference.

### BACKGROUND

The present disclosure relates to a process monitoring device for monitoring semiconductor device manufacturing processes and a semiconductor process apparatus including the same, and a process monitoring method thereof.

A semiconductor device is fabricated through a fabrication (FAB) process, an electrical die sorting process, and a package assembling process. During the FAB process, various thin layers are formed through processes such as chemical vapor deposition, physical vapor deposition, thermal oxidation, ion implantation, and ion diffusion and the formed thin layers may have patterns with electrical characteristics by etching process.

During the FAB process, to monitor whether processes are performed normally or process chambers leak or not, or determine end points of the processes, a device for monitoring a gas exhausted from the process chambers is used.

### SUMMARY

The present disclosure provides a process monitoring device for monitoring semiconductor manufacturing processes regardless of a pressure, a semiconductor processing apparatus including the same, and a process monitoring method thereof.

Embodiments of the inventive concept provide process monitoring devices including: a plasma unit that is configured to generate plasma by ionizing an exhaust gas and an optical emission spectroscopy unit that is configured to analyze an emission light of the plasma, wherein the plasma unit includes first and second electrodes spaced apart to face each other and including facing planes with a dielectric and a power supply unit applying a power to one of the first and second electrodes.

In some embodiments, the plasma unit may further include a gap adjustment member to adjust a gap between the first electrode and the second electrode.

In other embodiments, the gap adjustment member may include a first driving unit to move the first electrode relative to the second electrode.

In still other embodiments, the gap adjustment member may further include a second driving unit to move the second electrode relative to the first electrode.

In even other embodiments, the plasma unit may further include a control unit that is configured to control the first and second driving units to adjust a gap between the first and second electrodes responsive to a pressure of the exhaust gas.

In yet other embodiments, the control unit may control the first driving unit and the second driving units synchronously.

In further embodiments, when the exhaust gas has a second pressure higher than a first pressure, the control unit may control the first and second driving units to reduce a gap between the first and second electrodes to be less than a gap between the first and second electrodes when the exhaust gas has a first pressure.

In still further embodiments, the plasma unit may further include a control unit that is configured to control the power supply unit to change a voltage of the power supply responsive to a pressure of the exhaust gas.

In even further embodiments, if the exhaust gas has a second pressure higher than a first pressure, the control unit may control the power supply unit to apply a second voltage to the first electrode or the second electrode, the second voltage being higher than a first voltage used for plasma generation of the exhaust gas at the first pressure.

In yet further embodiments, the first and second electrodes may be disposed to have different gaps between the facing planes.

In yet further embodiments, the first and second electrodes may be obliquely disposed to gradually increase a gap between the facing planes along a first direction that the exhaust gas inflows.

In yet further embodiments, the first and second electrodes may be obliquely disposed to gradually decrease a gap between the facing planes along a first direction that the exhaust gas inflows.

In yet further embodiments, the first and second electrodes may be obliquely disposed to gradually increase a gap between the facing planes along a second direction perpendicular to a first direction that the exhaust gas inflows.

In other embodiments of the inventive concept, semiconductor manufacturing apparatuses include: a process chamber in which semiconductor processing processes are performed; a housing including an inflow port connected to an exhaust line of the process chamber and a partition dividing an inner space into a first region and a second region; a plasma unit provided in the first region of the housing and configured to ionize an exhaust gas of the process chamber, which inflows through the inflow port, to generate plasma; and an optical emission spectroscopy unit provided in the second region of the housing and configured to analyze light emitted from the plasma of the first region, wherein the plasma unit includes: first and second electrodes spaced apart to face each other and including facing planes with a dielectric; and a power supply unit configured to apply power to one of the first and second electrodes.

In some embodiments, the power may be AC power.

In other embodiments, the plasma unit may further include a gap adjustment member to adjust a gap between the first electrode and the second electrode.

In still other embodiments, the plasma unit may further include a control unit configured to control the power supply unit to change a voltage of the power that the power supply applies responsive to a pressure of the exhaust gas.

In even other embodiments, if the exhaust gas has a second pressure higher than a first pressure, the control unit may control the power supply unit to apply a second voltage to the first electrode or the second electrode, the second voltage being higher than a first voltage used for plasma generation of the exhaust gas at the first pressure.

In yet other embodiments, the first and second electrodes may be disposed to have different gaps between the facing planes.

In further embodiments, the first and second electrodes may be obliquely disposed to gradually increase a gap between the facing planes along a first direction that the exhaust gas inflows.

In still further embodiments, the first and second electrodes may be obliquely disposed to gradually decrease a gap between the facing planes along a first direction that the exhaust gas inflows.

In still other embodiments of the inventive concept, process monitoring methods include: providing an exhaust gas of a process chamber between electrodes with dielectrics; generating plasma by applying power to one of the electrodes; and monitoring a process being performed in the process chamber by analyzing a spectral signal of light emitted from the plasma.

In some embodiments, the process monitoring methods may further include, when the exhaust gas has a second pressure higher than a first pressure, adjusting a gap a gap between the electrodes to be smaller than a gap between the electrodes when the exhaust gas has the first pressure.

In other embodiments, the process monitoring methods may further include, when the exhaust gas has a second pressure higher than a first pressure, applying a second voltage to one of the electrodes, the second voltage being higher than a first voltage used for plasma generation of the exhaust gas at the first pressure.

In still other embodiments, a gap between facing planes of the electrodes may be different along a direction that the exhaust gas inflows between the electrodes.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a view illustrating a semiconductor processing apparatus according to an embodiment of the inventive concept;

FIG. 2 is a view illustrating a main body of a process monitoring device according to an embodiment of the inventive concept;

FIG. 3 is an enlarged view of the plasma unit of FIG. 2;

FIGS. 4A and 4B are views illustrating an operation of the plasma unit of FIG. 3;

FIG. 5 is a view illustrating a main body unit of a process monitoring device according to another embodiment of the inventive concept;

FIG. 6 is a view illustrating a main body unit of a process monitoring device according to another embodiment of the inventive concept;

FIGS. 7A and 7B are views illustrating an operation of the plasma unit of FIG. 6;

FIGS. 8A and 10B are views illustrating other embodiments of the plasma unit of FIG. 6;

FIG. 11 is a view illustrating a main body unit of a process monitoring device according to another embodiment of the inventive concept;

FIGS. 12A through 12C are views illustrating an operation of the plasma unit of FIG. 11;

FIGS. 13A through 13C are views illustrating an operation of the plasma unit of FIG. 11 according to another embodiment of the inventive concept;

FIG. 14 is a view illustrating a main body unit of a process monitoring device according to another embodiment of the inventive concept;

FIGS. 15A through 15C are views illustrating an operation of the plasma unit of FIG. 14 according to an embodiment of the inventive concept; and

FIGS. 16A through 16C are views illustrating an operation of the plasma unit of FIG. 14 according to another embodiment of the inventive concept.

### DETAILED DESCRIPTION OF THE EMBODIMENTS

Various example embodiments of the inventive concept will be described more fully hereinafter with reference to the accompanying drawings, in which some example embodiments of the inventive concept are shown. The present inventive concept may, however, be embodied in many different forms and should not be construed as limited to the example embodiments of the inventive concept set forth herein. Rather, these example embodiments of the inventive concept are provided so that this description will be thorough and complete, and will fully convey the scope of the present inventive concept to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout this description. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments of the inventive concept only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the inventive concept are described herein with reference to cross-sectional illustrations that are schematic illustrations of idealized example embodiments of the inventive concept (and intermediate structures). As such, variations from the shapes of the illustrations as a result, for example, of manufacturing techniques and/or tolerances, are to be expected. Thus, example embodiments of the inventive concept should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

### Embodiment 1

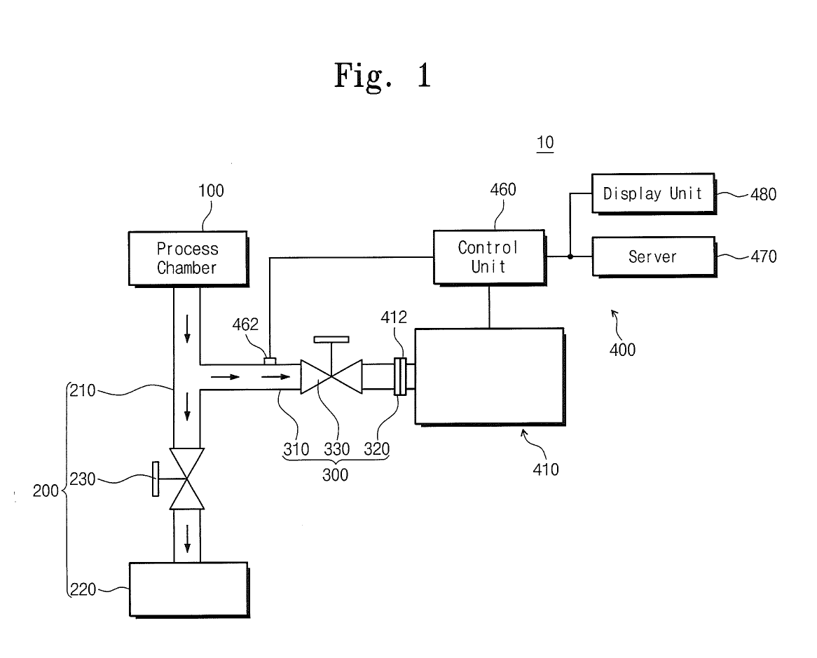

FIG. 1 is a view illustrating a semiconductor processing apparatus according to an embodiment of the inventive concept. Referring to FIG. 1, the semiconductor processing apparatus 10 includes a process chamber 100, an exhaust unit 200, a sampling unit 300, and a process monitoring device 400.

The process chamber 100 performs a substrate treating process. For example, the substrate treating process may be one of various semiconductor treating processes, such as a deposition process, an etching process, an ion implantation process, an ashing process, and a cleaning process. Each of the processes may be performed at low vacuum/high vacuum or atmospheric pressure according to process conditions. The exhaust unit 200 exhausts un-reacted gases or process by-products in the process chamber 100. The sampling unit 300 samples a portion of the exhaust gas exhausted through the exhaust unit 200.

The process monitoring device 400, i.e., a self-plasma optical emission spectroscopy (SPOES) device, generates plasma from the exhaust gas sampled by the sampling unit 300 and analyzes a spectrum of emission light from the plasma, thereby monitoring the substrate treating process in the process chamber 100.

In a semiconductor process, gases are used for chemical reaction according to related processes. Plasma generated from the gases emits light of its own original wavelength band components. Using this property, the SPOES device samples an exhaust gas exhausted from the process chamber and generates plasma from the exhaust gas, absorbs waves of a visible ray region and an ultraviolet region, which are emitted from the plasma, measures an intensity of each wavelength to analyze kinds and amounts of components constituting the plasma, and monitors semiconductor processes performed in the process chamber 100 based on an analyzed result.

The exhaust unit 200 includes an exhaust line 210 connected to an exhaust port (not shown) of the process chamber 100 and a pump 220 connected to the exhaust line 210. The pump 220 applies a negative pressure to the process chamber 100 through the exhaust line 210. Due to the negative pressure that the pump 220 applies, the inside of the process chamber 100 may be maintained at a predetermined process pressure, and its un-reacted gases and process by-products may be exhausted. A valve 230 for opening/closing a gas flow in the exhaust line 210 is installed at the exhaust line 210. Although not illustrated in the drawings, a purifier for purifying hazardous components of the exhaust gas may be equipped at the rear end of the pump 220 connected to the exhaust line 210.

The sampling unit 300 samples a portion of the exhaust gas exhausted from the process chamber 100 through the exhaust unit 200. The sampling unit 300 includes a sampling line 310 diverged from the exhaust line 210 and a connection port 320 connected to the end of the sampling line 310. A portion of the gas exhausted through the exhaust line 210 may flow into the sampling line 310 due to diffusion. A valve 330 for opening/closing an inflowing sample gas is installed at the sampling line 310. The process monitoring device 400 is coupled to the connection part 320.

The process monitoring device 400 generates plasma from a sample gas and analyzes components and concentration of the sample gas through an emission light spectrum analysis of the plasma. The process monitoring device 400 includes a main body unit 410, a control unit 460, a server 470, and a display unit 480.

The main body unit 410 has an inflow port 412 into which a sample gas flows and the inflow port 412 is coupled to the connection port 320 of the sampling unit 300. The main body unit 410 includes a plasma unit (not shown) ionizing the sample gas to generate plasma and an optical emission spectroscopy unit (not shown) receiving light emitted from the generated plasma to generate a signal for optical spectrum.

The control unit 460 analyzes components and concentration of a sample gas in real-time based on the signal from the optical emitting spectroscopy unit (not shown), and compares analyzed data with a reference value to monitor whether processes are performed normally in the process chamber 100 or the process chamber 100 leaks or not. Moreover, the control unit 460 analyzes a change according to the time of a delivered signal from the optical emission spectroscopy unit (not shown) such that end points of the processes may be determined. That is, if an intensity of an optical spectrum signal of gas used for a process is maintained strong and an intensity of a spectrum signal for reaction by-product is maintained weak, it means that process gases are not consumed anymore and reaction by-products are not generated. Thus, the control unit 460 determines that the process is finished.

Furthermore, the control unit 460 receives a pressure detect signal of the sample gas from a pressure sensor 462 installed at a sampling line 310 and then may control a plasma unit (not shown) in the main body unit 410. The pressure sensor 462 may be installed at the exhaust line 210 or the process chamber 100 besides the sampling line 310.

The server 470 receives analysis data from the control unit 460 and stores the received data and the display unit 480 displays a process monitoring result or a process end point analyzed in the control unit 460 for an operator to be capable of recognizing them.

In this embodiment, a case that the process monitoring device 400 is connected to the sampling line 310 diverged from the exhaust line 210 will be described as an example. However, the process monitoring device 400 may be directly connected to the exhaust line 210 or the process chamber 100. If the process monitoring device 400 is connected to the exhaust line 210, the process monitoring device 400 may be installed adjacent to the process chamber 100 to prevent disturbance interference.

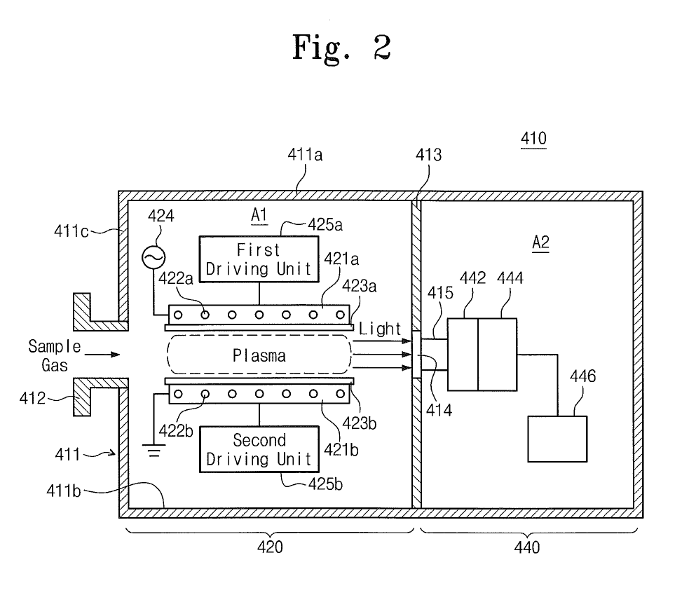

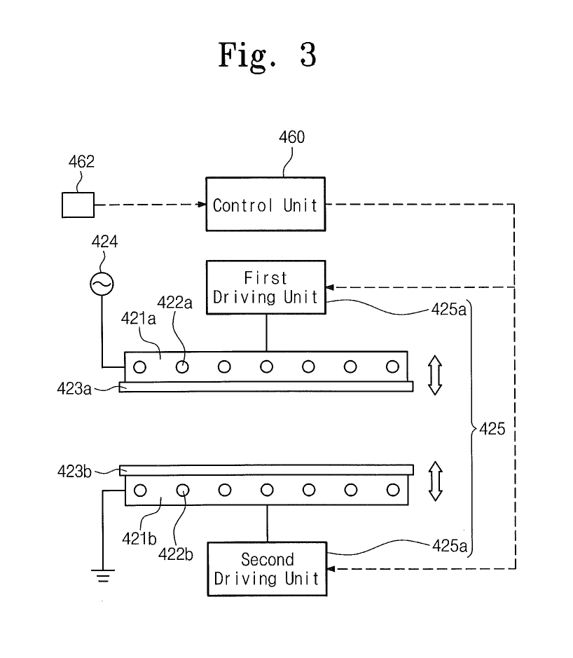

FIG. 2 is a view illustrating a main body of a process monitoring device according to an embodiment of the inventive concept. FIG. 3 is an enlarged view of the plasma unit of FIG. 2. Referring to FIGS. 2 and 3, a main body unit 410 of the process monitoring device 400 includes a housing 411, a plasma unit 420, and an optical emission spectroscopy unit 440.

The housing 411 includes an upper wall 411a and a lower wall 411b spaced apart to face each other in a vertical direction, and sidewalls 411c extending from the edge of the upper wall 411a to the edge of the lower wall 411b. An inflow port 412 into which a sample gas flows is coupled to an opening of the sidewall 411c at the front. A partition 413 is provided in the housing 411. The partition 413 divides the inner space of the housing 411 into a first region A1 and a second region A2. The first region A1 is fluidly connected with the inflow port 412 and includes a plasma unit 420. The second region A2 is positioned opposite to the first region A1 based on the partition 413 and includes an optical emission spectroscopy unit 440.

The plasma unit 420 ionizes the sample gas inflowing into the first region A1 through the inflow port 412 and generates plasma. Light is emitted from the generated plasma. The emitted light is delivered to the optical emission spectroscopy unit 440 of the second region A2 through a window 414 provided in the partition 413 and an optical cable connected to the window 414. The optical emission spectroscopy unit 440 generates a signal for a spectrum of the delivered emission light.

The plasma unit 420 generates plasma using electrodes 421a and 421b of a dielectric barrier discharge (DBD) type. The first electrode 421a and the second electrode 421b may have a flat plate form. The first electrode 421a is disposed over a space between the inflow port 412 and the window 414 and the second electrode 421b is disposed below a space between the inflow port 412 and the window 414 to face the first electrode 421a. Cooling lines 422a and 422b, where a refrigerant flows, may be provided in the first electrode 421a and the second electrode 421b, respectively.

Dielectrics 423a and 423b are provided at the facing planes of the first electrode 421a and the second electrode 421b. The dielectrics 423a and 423b may be formed of a ceramic material. For example, a ceramic, such as a silicon dioxide, an aluminum oxide, a zirconium dioxide, a titanium dioxide, and an yttrium oxide may be used as a dielectric. A power supply unit 424 applying an AC voltage is connected to the first electrode 421a and the second electrode 421b is grounded. The first electrode 421a is used as a power electrode and the second electrode 421b is used as a ground electrode.

A sample gas flows into a space between the first electrode 421a and the second electrode 421b through the inflow port 412 and when the power supply unit 424 applies an AC voltage to the first electrode 421a, the sample gas is ionized to generate plasma.

However, since an inner atmosphere of the process chamber 100 of FIG. 1 may vary from a low pressure atmosphere close to vacuum to a normal pressure atmosphere according to types of processes performed in the process chamber 100, a pressure of the sample gas may have different values. Accordingly, to generate plasma from the sample gas having various pressure ranges, a gap between the first electrode 421a and the second electrode 421b needs to be adjusted according to a pressure of the sample gas. For example, if the sample gas is in a lower pressure than an atmospheric pressure, in order to generate plasma, a gap between the first electrode 421a and the second electrode 421b needs to be adjusted broader than that of when plasma is generated from the sample gas in a normal pressure state.

A gap adjustment member 425 adjusts a gap between the first electrode 421a and the second electrode 421b. The gap adjustment member 425 includes a first driving unit 425a and a second driving unit 425b. The first driving unit 425a moves the first electrode 421a in a vertical direction with respect to the second electrode 421b. The second driving unit 425b moves the second electrode 421b in a vertical direction with respect to the first electrode 421a. The first driving unit 425a and the second driving unit 425b may be a linear driving member or a rotating driving member combined with a power converting member that converts a rotating power into a linear driving power.

The control unit 460 receives a predetermined input value of a sample gas according to types of processes performed in the process chamber 100 or receives a pressure value of a sample gas from the pressure sensor 462 in real-time such that the first and second driving units 425a and 425b may be controlled to adjust a gap between the first and second electrodes 421a and 421b according to a pressure of a sample gas. The control unit 460 may separately or synchronously control the first and second driving units 425a and 425b.

In the embodiment, a case that both the first electrode 421a and second electrode 421b move in a vertical direction to adjust a gap therebetween was described. However, with one of the first and second electrodes 421a and 421b fixed, the other one may move in a vertical direction to adjust a gap between the first and second electrodes 421a and 421b, thereby constituting the plasma unit 420.

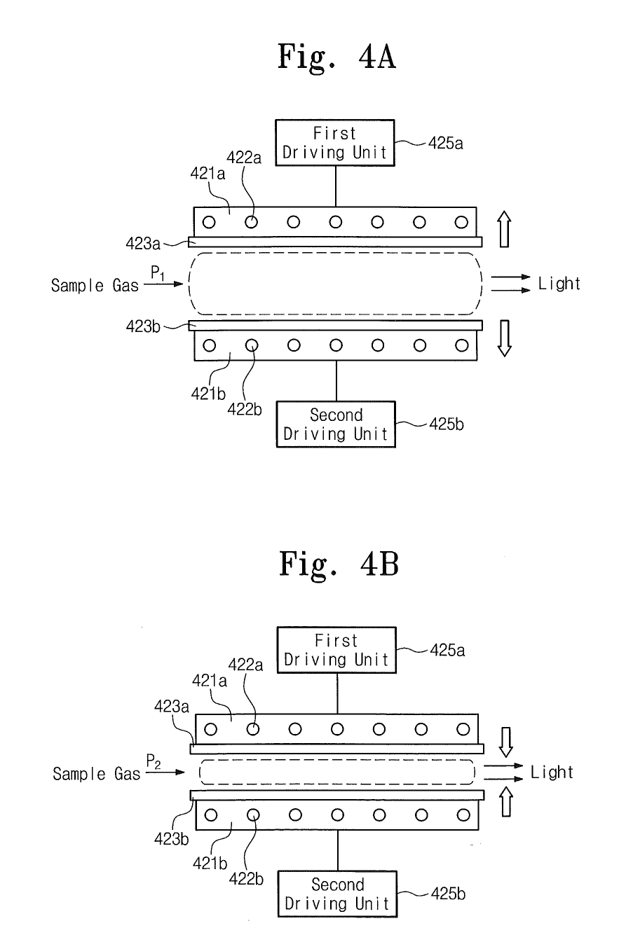

FIGS. 4A and 4B are views illustrating an operation of the plasma unit of FIG. 3. Referring to FIG. 4A, if a sample gas has a low pressure P₁ lower than an atmospheric pressure, to broaden a gap between the electrodes 421a and 421b, the first driving unit 425a raises the first electrode 421a and the second driving unit 425b descends the second electrode 421b. On the contrary, referring to FIG. 4B, if a sample gas has an atmospheric pressure P₂ higher than the low pressure P₁, to narrow a gap between the electrodes 421a and 421b, the first driving unit 425a descends the first electrode 421a and the second driving unit 425b raises the second electrode 421b. In the same manner, when a gap between the first and second electrodes 421a and 421b is adjusted, a pressure range of a sample gas for generating plasma may broaden. Accordingly, the process monitoring device 400 may monitor semiconductor manufacturing processes regardless of a pressure of a sample gas.

Again, referring to FIG. 2, the emission light of plasma generated in the plasma unit 420 penetrates the window 414. The window 414 may be formed of a quartz material and may be disposed facing the inflow port 412. The emission light penetrating the window 313 is delivered to the optical emission spectroscopy unit 440 through the optical cable 415.

The optical emission spectroscopy unit 440 includes a spectroscopy unit 442, a detection unit 444, and a signal converting unit 446. The spectroscopy unit 442 receives plasma emission light through the optical cable 415 and spectrumizes the emission light by a spectrum of a corresponding wavelength. A charge coupled device (CCD) array may be used as the detecting unit 444 and the detecting unit 444 obtains an analog signal for a spectroscopic spectrum. The analog signal of the spectroscopic spectrum may have different signal intensities according to types and concentration of a sample gas. The signal converting unit 446, i.e., an A/D converter, converts an analog signal into a digital signal. The converted digital signal is delivered to the control unit 460 of FIG. 1. The control unit 460 analyzes components and concentration of the sample gas, based on the delivered signal, so as to monitor whether the processing processes are performed normally or determine end points of the processes.

### Embodiment 2

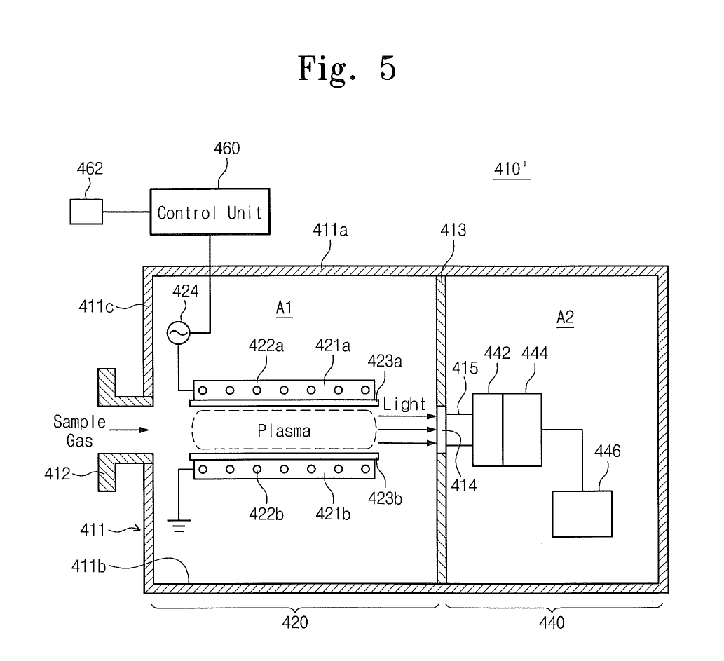

FIG. 5 is a view illustrating a main body unit of a process monitoring device according to another embodiment of the inventive concept. The main body unit 410′ of the process monitoring device of FIG. 5 is the same as the main body unit 410 of the process monitoring device of FIG. 2 except for the first driving unit 425a of FIG. 2 and the second driving unit 425b of FIG. 2. However, the main body unit 410′ of FIG. 5 does not adjust a gap between the electrodes 421a and 421b, but adjusts a voltage of an AC power applied to the first electrode 421a (i.e., a power electrode) to generate plasma from a sample gas of a different pressure range.

The control unit 460 receives a predetermined input value of a sample gas according to types of processes performed in the process chamber 100 of FIG. 1 or receives a pressure value of a sample gas from the pressure sensor 462 in real-time such that the power supply unit 424 may be controlled to change the voltage of AC power that the power supply unit 424 applies. For example, when a sample gas has a low pressure less than an atmospheric pressure, the control unit 460 may control the power supply unit 424 to apply a voltage, which is less than a voltage used for plasma discharge of an atmospheric gas, to the first electrode 421a. On the contrary, when a sample gas has an atmospheric pressure, the control unit 460 may control the power supply unit 424 to apply a voltage, which is greater than a voltage used for plasma discharge of an atmospheric gas, to the first electrode 421a.

In the same manner, when a voltage of AC power applied to the first electrode 421a is adjusted, a pressure range of a sample gas for generating plasma may broaden. Accordingly, the process monitoring device 400 may monitor semiconductor manufacturing processes regardless of a pressure of a sample gas.

### Embodiment 3

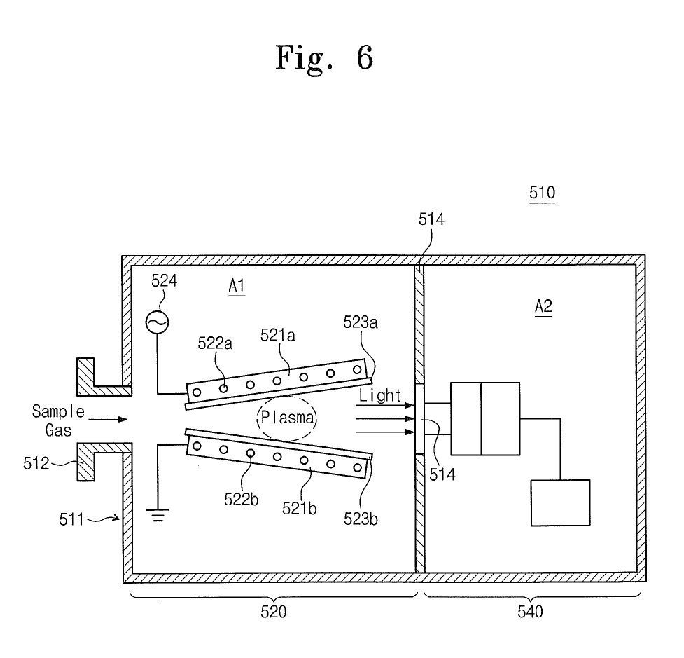

FIG. 6 is a view illustrating a main body unit of a process monitoring device according to another embodiment of the inventive concept. Referring to FIG. 6, the main body unit 510 of the process monitoring device includes a housing 511, a plasma unit 520, and an optical emission spectroscopy unit 540. Because the housing 511 and the optical emission spectroscopy unit 540 are the same as those 411 and 440 of FIG. 2, their detailed description will be omitted.

The plasma unit 520 generates plasma using electrodes 521a and 521b of a DBD type. The first electrode 521a and the second electrode 521b may have a flat plate form. The first electrode 521a is disposed over a space between the inflow port 512 and the window 514 and the second electrode 521b is disposed below a space between the inflow port 512 and the window 514. The first electrode 521a and the second electrode 521b may be obliquely disposed so as to gradually change a gap between their facing planes. For example, the first electrode 521a and the second electrode 521b may be obliquely disposed so as to gradually increase a gap between their facing planes along a flowing direction of a sample gas. Cooling lines 522a and 522b, where a refrigerant flows, may be provided in the first electrode 521a and the second electrode 521b, respectively.

Dielectrics 523a and 523b are provided at the facing planes of the first electrode 521a and the second electrode 521b. The dielectrics 523a and 523b may be formed of a ceramic material. A power supply unit 524 applying an AC voltage is connected to the first electrode 521a and the second electrode 521b is grounded. The first electrode 521a is used as a power electrode and the second electrode 521b is used as a ground electrode.

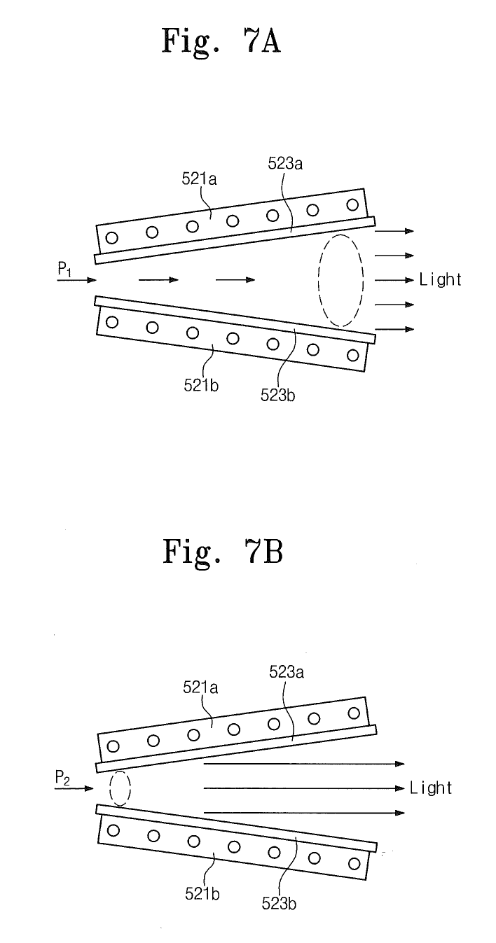

When a sample gas flows into the inflow port 512 and the power supply unit 524 applies an AC voltage to the first electrode 521a, the sample gas is ionized and plasma is generated. At this point, an occurrence position of the plasma may vary according to a pressure of the sample gas. That is, with respect to a sample gas of a specific pressure, plasma occurs at a position where a gap of the electrodes 521a and 521b for generating plasma is maintained. For example, as shown in FIG. 7A, if a sample gas has a lower pressure P₁ than an atmospheric pressure, because a gap between electrodes 521a and 521b needs to broaden to generate plasma, the plasma occurs at the rear ends of the electrodes 521a and 521b. On the contrary, referring to FIG. 7B, if a sample gas is at an atmospheric pressure P₂, because a gap between electrodes 521a and 521b needs to narrow to generate plasma, the plasma occurs at the front ends of the electrodes 521a and 521b. In the same manner, because plasma occurs at different positions according to a pressure of a sample gas, the process monitoring device 400 may monitor semiconductor manufacturing processes regardless of a pressure of a sample gas.

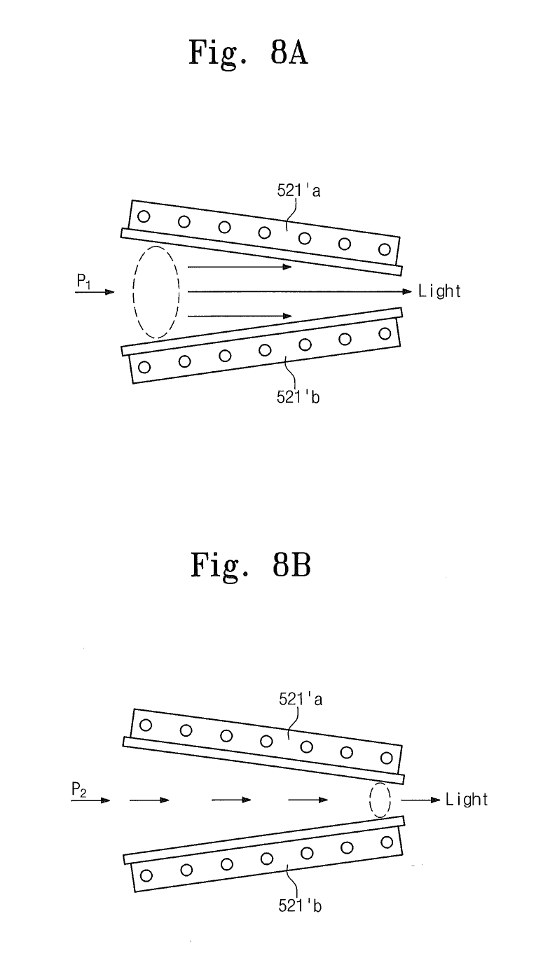

As shown in FIGS. 8A and 8B, the first electrode 521′a and the second electrode 521′b may be obliquely disposed along a flowing direction of a sample gas so as to gradually reduce a gap between the facing planes. In this case, plasma occurrence positions varying according to a pressure of a sample gas is opposite to those of FIGS. 7A and 7B.

As shown in FIGS. 9A and 9B, the first electrode 521″a and the second electrode 521″b may be obliquely disposed along a traverse direction perpendicular to a flowing direction of a sample gas so as to gradually broaden a gap between facing planes. For example, as shown in FIG. 9A, if a pressure of a sample gas is at a low pressure P₁ of a high vacuum, plasma occurs at a region where a gap between the electrodes 521″a and 521″b is broad, i.e., a partial region of the right of the electrodes 521″a and 521″b. On the contrary, as shown in FIG. 9B, if a pressure of a sample gas is at an atmospheric pressure P₂, plasma occurs at a region where a gap between the electrodes 521″a and 521″b is narrow, i.e., a partial region of the left of the electrodes 521″a and 521″b. At this point, the plasma occurs along a flowing direction of a sample gas.

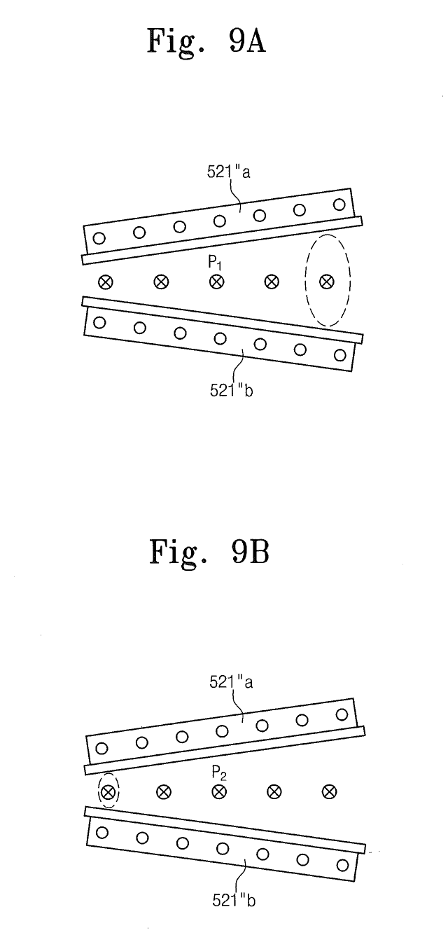

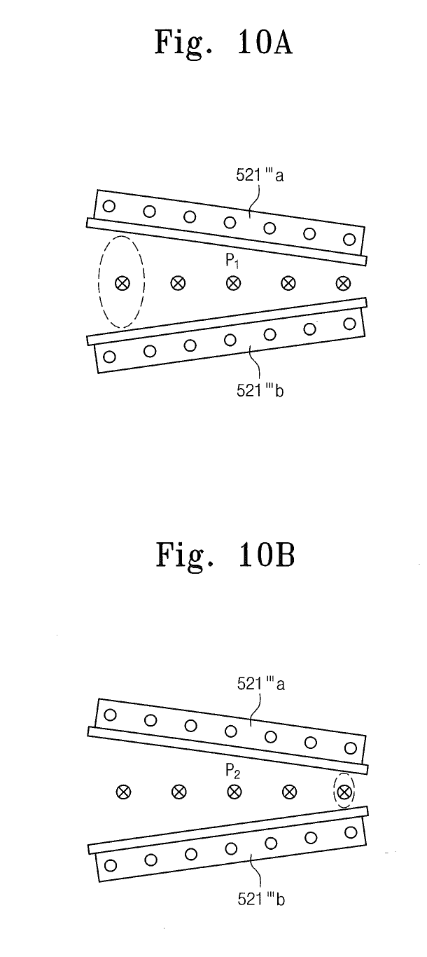

As shown in FIGS. 10A and 10B, the first electrode 521′″a and the second electrode 521′″b may be obliquely disposed along a transverse direction perpendicular to a flowing direction of a sample gas so as to gradually reduce a gap between facing planes. In this case, as shown in FIG. 10A, if a pressure of a sample gas is at a low pressure P₁ of a high vacuum, plasma occurs at a left-partial region where a gap between the electrodes 521′″a and 521′″b is broad. On the contrary, as shown in FIG. 10B, if a pressure of a sample gas is at an atmospheric pressure P₂, plasma occurs at a right-partial region where a gap between the electrodes 521′″a and 521′″b is narrow. At this point, the plasma occurs long along a flowing direction of a sample gas.

### Embodiment 4

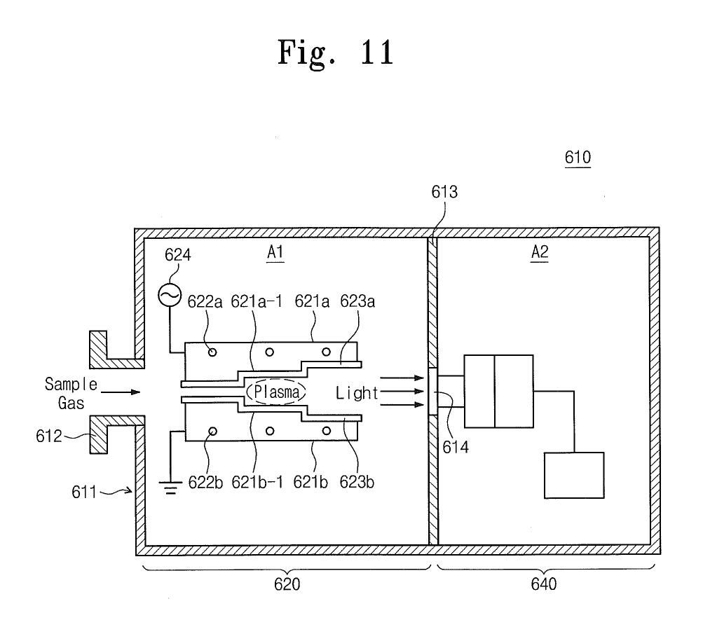

FIG. 11 is a view illustrating a main body unit of a process monitoring device according to another embodiment of the inventive concept. Referring to FIG. 11, a main body unit 610 of the process monitoring device includes a housing 611, a plasma unit 620, and an optical emission spectroscopy unit 640. Because the housing 611 and the optical emission spectroscopy unit 640 are the same as the housing 411 and optical emission spectroscopy unit 440 of FIG. 2, their detailed description will be omitted.

The plasma unit 620 generates plasma using electrodes 621a and 621b of a DBD type. The first electrode 621a is disposed over a space between the inflowing port 612 and the window 614 and the second electrode 621b is disposed below a space between the inflowing port 612 and the window 614 so as to face the first electrode 621a.

The first electrode 621a may have a plate form and a first step height unit 621a-1 of a step shape ascending upward along a flowing direction of a sample gas is formed at the bottom of the first electrode 621a. The second electrode 621b may have a plate form and a second step height unit 621b-1 of a step shape descending downward along a flowing direction of a sample gas is formed at the top of the second electrode 621b. The first step height unit 621a-1 and the second step height unit 621b-1 are formed facing each other symmetrically. This embodiment exemplifies a case that the first step height unit 621a-1 and the second step height unit 621b-1 have three steps, but the inventive concept is not limited thereto. A plurality of steps may be provided to allow the first step height unit 621a-1 and the second step height unit 621b-1 to correspond to kinds of sampling gases to be monitored.

Cooling lines 622a and 622b, where a refrigerant flows, may be provided in the first electrode 621a and the second electrode 621b, respectively. Dielectrics 623a and 623b are provided at the facing planes of the first electrode 621a and the second electrode 632b. The dielectrics 623a and 623b may be formed of a ceramic material. A power supply unit 624 applying an AC voltage is connected to the first electrode 621a and the second electrode 621b is grounded. The first electrode 621a is used as a power electrode and the second electrode 621b is used as a ground electrode.

When a sample gas flows into the first electrode 621a and the second electrode 621b through the inflow port 612 and the power supply unit 624 applies an AC voltage to the first electrode 621a, the sample gas is ionized and plasma is generated. At this point, an occurrence position of the plasma may vary according to a pressure of the sample gas. That is, with respect to a sample gas of a specific pressure, plasma occurs at a position where a gap of the electrodes 621a and 621b for generating plasma is maintained.

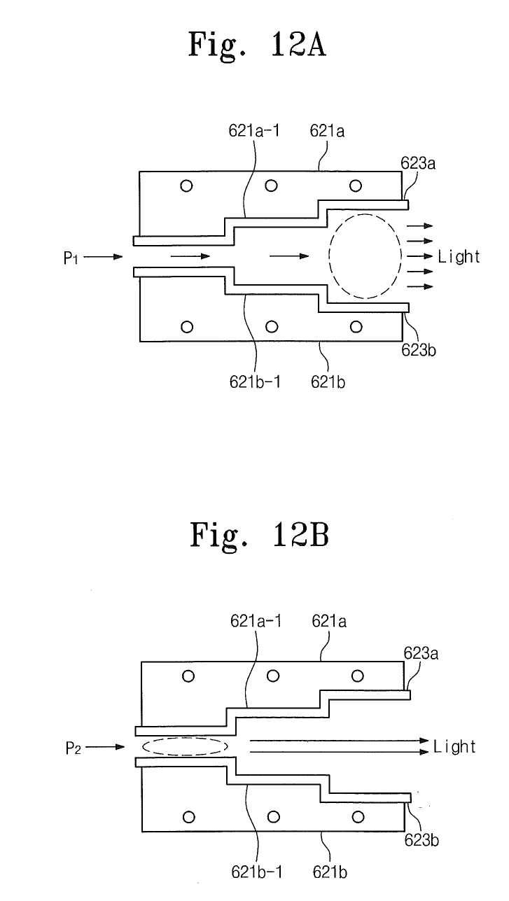

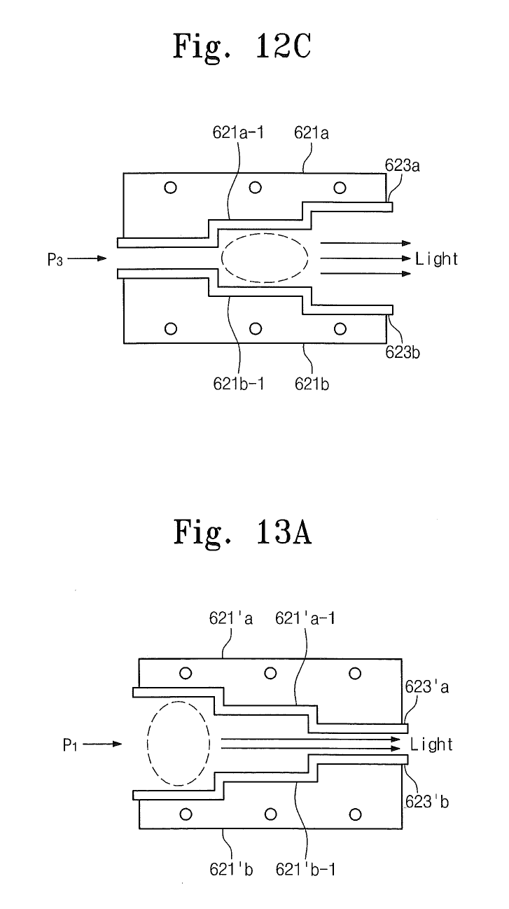

For example, as shown in FIG. 12A, if a pressure of a sample gas is at a low pressure P₁ of a high vacuum, because a gap between electrodes 621a and 621b needs to broaden to generate plasma, the plasma occurs at the rear ends of the first step height unit 621a-1 and the second step height unit 621b-1. On the contrary, referring to FIG. 12B, if a sample gas is at an atmospheric pressure P₂, because a gap between electrodes 621a and 621b needs to narrow to generate plasma, the plasma occurs at the front ends of the first step height unit 621a-1 and the second step height unit 621b-1. Moreover, as shown in FIG. 12C, if a pressure P₃ of a sample gas is between the pressures P₁ and P₂, plasma may occur at the center region between the first step height unit 621a-1 and the second step height unit 621b-1. In the same manner, because plasma occurs at different positions according to a pressure of a sample gas, the process monitoring device 400 may monitor semiconductor manufacturing processes regardless of a pressure of a sample gas.

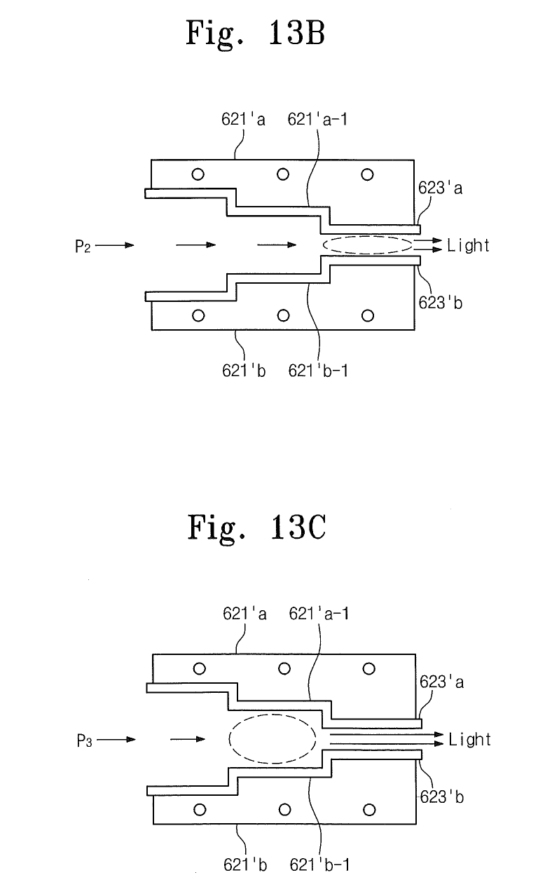

As shown in FIGS. 13A through 13B, a first step height unit 621′a-1 of a step shape descending downward along a flowing direction of a sample gas is formed at the bottom of the first electrode 621′a. A second step height unit 621′b-1 of a step shape ascending upward along a flowing direction of a sample gas is formed at the top of the first electrode 621′b. In this case, plasma occurrence positions varying according to a pressure of a sample gas is opposite to those of FIGS. 12A to 12C.

For example, as shown in FIG. 13A, if a pressure of a sample gas is at a low pressure P₁ of a high vacuum, because a gap between electrodes 621′a and 621′b needs to broaden to generate plasma, the plasma occurs at the front ends of the first step height unit 621′a-1 and the second step height unit 621′b-1. On the contrary, referring to FIG. 13B, if a sample gas is at an atmospheric pressure P₂, because a gap between electrodes 621′a and 621′b needs to narrow to generate plasma, the plasma occurs at the rear ends of the first step height unit 621′a-1 and the second step height unit 621b′-1. Moreover, as shown in FIG. 13C, if a pressure P₃ of a sample gas is between the pressures P₁ and P₂, plasma may occur at the center region of the first step height unit 621′a-1 and the second step height unit 621′b-1.

### Embodiment 5

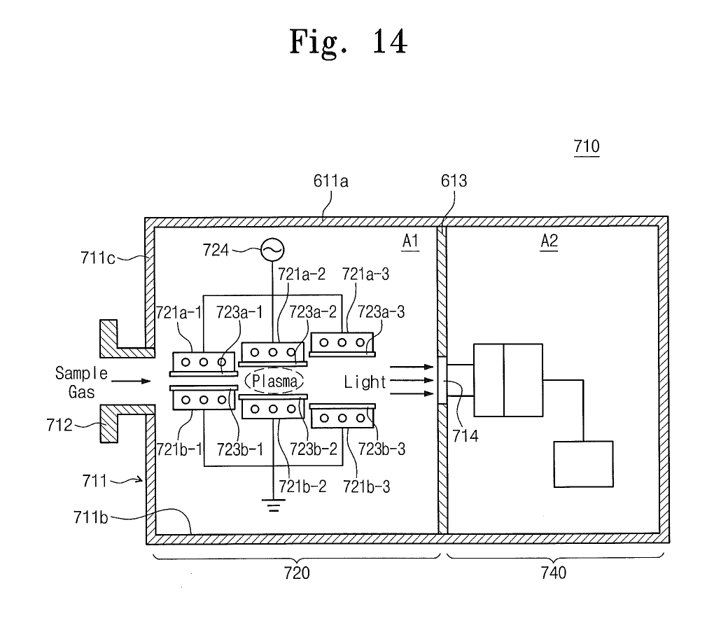

FIG. 14 is a view illustrating a main body unit of a process monitoring device according to another embodiment of the inventive concept. Referring to FIG. 14, a main body unit 710 of the process monitoring device includes a housing 711, a plasma unit 720, and an optical emission spectroscopy unit 740. Because the housing 711 and the optical emission spectroscopy unit 740 are the same as the housing 411 and optical emission spectroscopy unit 440 of FIG. 2, their detailed description will be omitted.

The plasma unit 720 generates plasma using electrodes of a DBD type. The first electrodes 721a-1, 721a-2, and 721a-3 are disposed over a space between the inflowing port 712 and the window 714. Each of the first electrodes 721a-1, 721a-2, and 721a-3 may be disposed at a different height according to an inflowing direction of a sampling gas. For example, the first electrodes 721a-1, 721a-2, and 721a-3 may be sequentially disposed at a higher position according to an inflowing direction of a sample gas. The second electrodes 721b-1, 721b-2, and 721b-3 may be disposed below a space between the inflowing port 712 and the window 714 to face the first electrodes 721a-1, 721a-2, and 721a-3. Each of the second electrodes 721b-1, 721b-2, and 721b-3 may be disposed at a different height according to an inflowing direction of a sample gas. For example, the second electrodes 721b-1, 721b-2, and 721b-3 may be sequentially disposed at a lower position according to an inflowing direction of a sample gas.

This embodiment exemplifies a case that the first electrodes 721a-1, 721a-2, and 721a-3 and the second electrodes 721b-1, 721b-2, and 721b-3 are provided in three, respectively, but the inventive concept is not limited thereto. The number of the first electrodes 721a-1, 721a-2, and 721a-3 and the second electrodes 721b-1, 721b-2, and 721b-3 may be provided in any number to correspond to kinds of sample gases to be monitored.

Dielectrics 723a-1, 723a-2, and 723a-3 are provided at the bottom of the first electrodes 721a-1, 721a-2, and 721a-3, respectively, and dielectrics 723b-1, 723b-2, and 723b-3 are provided at the top of the second electrodes 721b-1, 721b-2, and 721b-3, respectively. The dielectrics may be formed of a ceramic material. A power supply unit 724 applying an AC voltage is connected to the first electrodes 721a-1, 721a-2, and 721a-3, and the second electrodes 721b-1, 721b-2, and 721b-3 are grounded. The first electrodes 721a-1, 721a-2, and 721a-3 are used as power electrodes and the second electrodes 721b-1, 721b-2, and 721b-3 are used as ground electrodes.

When a sample gas flows between the first electrodes 721a-1, 721a-2, and 721a-3 and the second electrodes 721b-1, 721b-2, and 721b-3 through the inflow port 712 and the power supply unit 724 applies an AC voltage to the first electrodes 721a-1, 721a-2, and 721a-3, the sample gas is ionized and plasma is generated. At this point, an occurrence position of the plasma may vary according to a pressure of the sample gas. That is, with respect to a sample gas of a specific pressure, plasma occurs at a position where a gap of the electrodes for generating plasma is maintained.

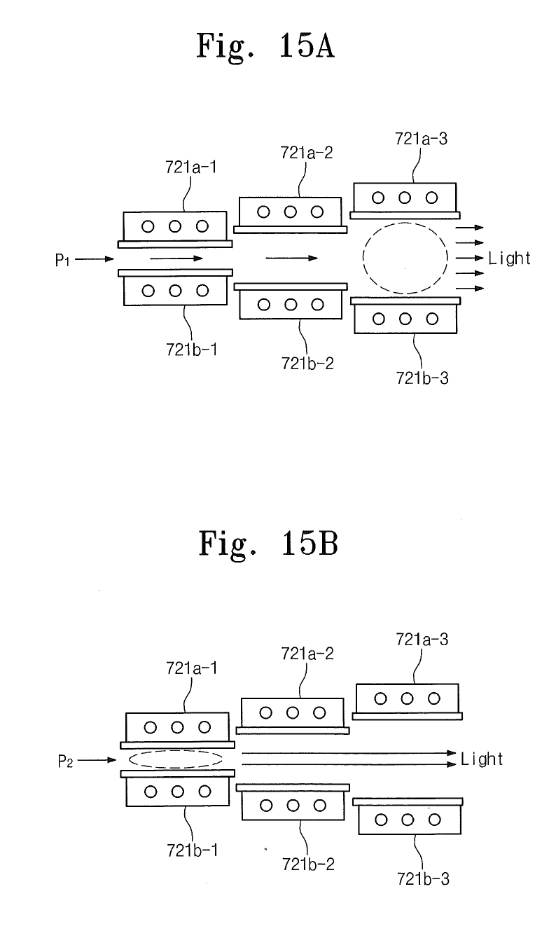

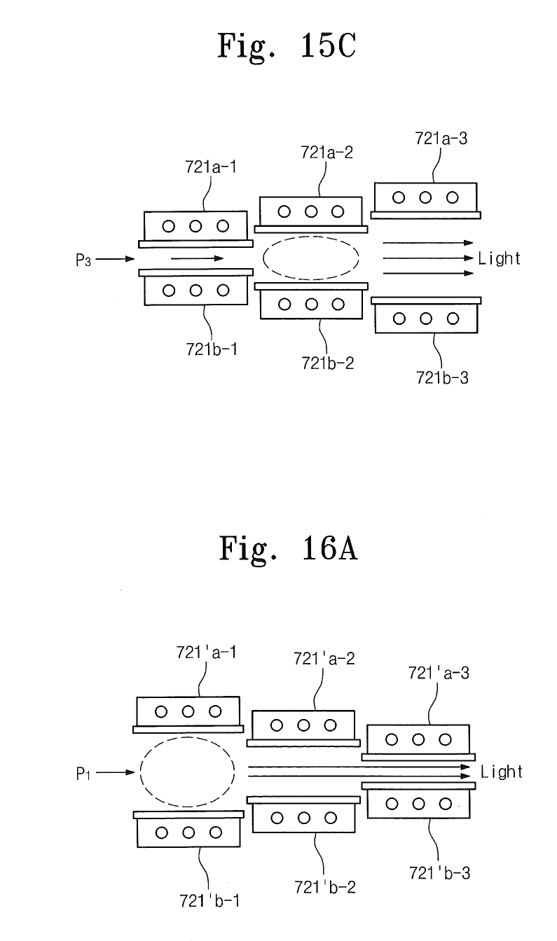

For example, as shown in FIG. 15A, if a pressure of a sample gas is at a low pressure P₁ of a high vacuum, because a gap between electrodes needs to broaden to generate plasma, the plasma occurs between the electrodes 721a-3 and 721b-3 at the rear end. On the contrary, referring to FIG. 15B, if a sample gas is at an atmospheric pressure P₂, because a gap between electrodes needs to narrow to generate plasma, the plasma occurs between the electrodes 721a-1 and 721b-1 at the front end. Moreover, as shown in FIG. 15C, if a pressure P₃ of a sample gas is between the pressures P₁ and P₂, plasma may occur at the between the electrodes 721a-2 and 721b-2 in the center region. In the same manner, because plasma occurs at different positions according to a pressure of a sample gas, the process monitoring device 400 may monitor semiconductor manufacturing processes regardless of a pressure of a sample gas.

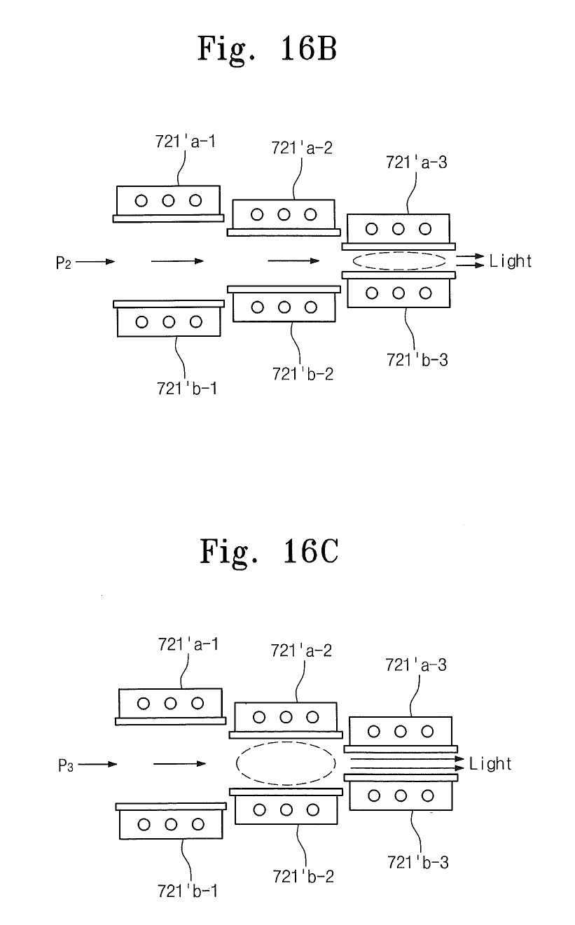

As shown in FIGS. 16A through 16C, the first electrodes 721′a-1, 721′a-2, and 721′a-3 may be sequentially disposed at a lower position along an inflowing direction of a sample gas. The second electrodes 721b′-1, 721b′-2, and 721b′-3 may be sequentially disposed at a higher position along an inflowing direction of a sample gas to face the first electrodes 721′a-1, 721′a-2, and 721′a-3. In this case, plasma occurrence positions varying according to a pressure of a sample gas is opposite to those of FIGS. 15A through 15C.

For example, as shown in FIG. 16A, if a sample gas is at a low pressure P₁ lower than an atmospheric pressure, because a gap between electrodes needs to broaden to generate plasma, the plasma occurs between the electrodes 721′a-1 and 721′b-1 at the front end. On the contrary, referring to FIG. 16B, if a sample gas is at an atmospheric pressure P₂, because a gap between electrodes needs to narrow to generate plasma, the plasma occurs between the electrodes 721′a-3 and 721′b-3 at the rear end. Moreover, as shown in FIG. 16C, if a pressure P₃ of a sample gas is between the pressures P₁ and P₂, plasma may occur between the electrodes 721′a-2 and 721′b-2 at the center region. In the same manner, because plasma occurs at different positions according to a pressure of a sample gas, the process monitoring device 400 may monitor semiconductor manufacturing processes regardless of a pressure of a sample gas.

As mentioned above, a process monitoring device, i.e., a SPOES device, generates plasma by applying an AC voltage to an electrode of a DBD type and broadens an available pressure range through an electrode's gap adjustments, an applied voltage's adjustments, or an electrode's form and arrangement structure changes, such that all semiconductor manufacturing processes may be monitored.

According to embodiments of the inventive concept, a semiconductor manufacturing process may be monitored regardless of a pressure by broadening an available pressure range of a process monitoring device.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

1. A process monitoring device comprising:
a plasma unit that is configured to ionize an exhaust gas to generate plasma; and
an optical emission spectroscopy unit that is configured to analyze an emission light of the plasma;
wherein the plasma unit comprises:
first and second electrodes spaced apart to face each other and including facing planes with a dielectric; and
a power supply unit that is configured to apply power to one of the first and second electrodes.

2. The process monitoring device of claim 1, wherein the plasma unit further comprises a gap adjustment member that is configured to adjust a gap between the first electrode and the second electrode.

3. The process monitoring device of claim 2, wherein the gap adjustment member comprises a first driving unit that is configured to move the first electrode relative to the second electrode.

4. The process monitoring device of claim 3, wherein the gap adjustment member further comprises a second driving unit that is configured to move the second electrode relative to the first electrode.

5. The process monitoring device of claim 4, wherein the plasma unit further comprises a control unit that is configured to control the first and second driving units to adjust a gap between the first and second electrodes responsive to a pressure of the exhaust gas.

6. The process monitoring device of claim 5, wherein the control unit controls the first and second driving units such that a first gap between the first and second electrodes when the exhaust gas has a first pressure is smaller than a second gap between the first and second electrodes when the exhaust gas has a second pressure wherein the first pressure is greater than the second pressure.

7. The process monitoring device of claim 1, wherein the plasma unit further comprises a control unit that is configured to control the power supply unit to change a voltage of the power supply responsive to a pressure of the exhaust gas.

8. The process monitoring device of claim 7, wherein the control unit is configured to control the power supply unit to apply a second voltage to the first electrode or the second electrode when the exhaust gas has a second pressure and to apply a first voltage to the first electrode or the second electrode when the exhaust gas has a first pressure wherein the second voltage is greater than the first voltage and the second pressure is greater than the first pressure.

9. The process monitoring device of claim 1, wherein the first and second electrodes are disposed to have different gaps between the facing planes.

10. The process monitoring device of claim 9, wherein the first and second electrodes are obliquely disposed to gradually increase a gap between the facing planes along a first direction that the exhaust gas inflows.

11. The process monitoring device of claim 9, wherein the first and second electrodes are obliquely disposed to gradually decrease a gap between the facing planes along a first direction that the exhaust gas inflows.

12. The process monitoring device of claim 9, wherein the first and second electrodes are obliquely disposed to gradually increase a gap between the facing planes, along a second direction perpendicular to a first direction that the exhaust gas inflows.

13. A semiconductor processing apparatus comprising:
a process chamber in which semiconductor manufacturing processes are performed;
a housing including an inflow port connected to an exhaust line of the process chamber and a partition dividing an inner space into a first region and a second region;
a plasma unit provided in the first region of the housing and ionizing an exhaust gas of the process chamber, which inflows through the inflow port, to generate plasma; and
an optical emission spectroscopy unit provided in the second region of the housing and configured to analyze light emitted from the plasma of the first region,
wherein the plasma unit comprises:
first and second electrodes spaced apart to face each other and including facing planes with a dielectric; and
a power supply unit that is configured to apply power to one of the first and second electrodes.

14. The semiconductor processing apparatus of claim 13, wherein the power is AC power.

15. The semiconductor processing apparatus of claim 14, wherein the plasma unit further comprises a gap adjustment member to adjust a gap between the first electrode and the second electrode.

16. The semiconductor processing apparatus of claim 14, wherein the plasma unit further comprises a control unit that is configured to control the power supply unit to change a voltage of the power supply responsive to a pressure of the exhaust gas.

17. The semiconductor processing apparatus of claim 14, wherein the control unit is configured to control the power supply unit to apply a second voltage to the first electrode or the second electrode when the exhaust gas has a second pressure and to apply a first voltage to the first electrode or the second electrode when the exhaust gas has a first pressure wherein the second voltage is greater than the first voltage and the second pressure is greater than the first pressure.

18. The semiconductor processing apparatus of claim 14, wherein the first and second electrodes are disposed to have different gaps between the facing planes.

19. The semiconductor processing apparatus of claim 18, wherein the first and second electrodes are obliquely disposed to gradually increase a gap between the facing planes along a first direction that the exhaust gas inflows.

20. The semiconductor processing apparatus of claim 18, wherein the first and second electrodes are obliquely disposed to gradually decrease a gap between the facing planes along a first direction that the exhaust gas inflows.

21-24. (canceled)
